(19) United States
(12) Patent Application Publication
(10) Pub. No.: US 2026/0301212 A1
(43) Pub. Date: Oct. 1, 2026

(54) INFORMATION COLLECTION DEVICE, INFORMATION COLLECTION METHOD, AND NON-TRANSITORY RECORDING MEDIUM

(71) Applicant: CASIO COMPUTER CO., LTD., Tokyo (JP)

(72) Inventor: Naotomo MIYAMOTO, Tokyo (JP)

(73) Assignee: CASIO COMPUTER CO., LTD., Tokyo (JP)

(21) Appl. No.: 19/440,693

(22) Filed: Jan. 6, 2026

(30) Foreign Application Priority Data
Mar. 25, 2025 (JP) 2025-049291

(51) Int. Cl. G06T 7/70; G06T 1/60; G06V 10/145; G06V 20/56

(52) U.S. Cl. CPC G06T 7/70; G06T 1/60; G06V 10/145; G06V 20/56

(57) ABSTRACT

An information collection device includes a moving body on which a first camera is mounted and at least one processor. The processor derives, based on an image obtained by imaging multiple registered light sources having information about a light emission pattern and information about an installation coordinate position stored in a memory, a coordinate position where the first camera images the registered light sources and a first direction in which the first camera images the registered light sources and derives, by detecting a second direction allowing an unregistered light source to fall within an angle of view of the first camera as viewed from a coordinate position where the registered light sources are imaged, an installation coordinate position where the unregistered light source is installed, and stores information about the derived installation coordinate position in the memory in association with information as information about a new registered light source.

### CROSS-REFERENCE TO RELATED APPLICATIONS

This application is based upon and claims the benefit of priority under 35 USC 119 of Japanese Patent Application No. 2025-049291, filed on Mar. 25, 2025, the entire disclosure of which, including the description, claims, drawings, and abstract, is incorporated herein by reference in its entirety.

### FIELD OF THE INVENTION

This application relates to an information collection device, an information collection method, and a non-transitory recording medium.

### BACKGROUND OF THE INVENTION

Unexamined Japanese Patent Application Publication No. 2014-235102 describes a technology for detecting a lighting device that performs visible light communication, based on illuminating light received by a light receiver provided in a movable position estimation device and calculating a position of the position estimation device.

### SUMMARY OF THE INVENTION

One aspect of an information collection device according to the present disclosure includes a moving body on which a first camera is mounted and at least one processor, and the at least one processor derives, based on an image obtained by imaging a plurality of registered light sources each of which has information about a light emission pattern and information about an installation coordinate position stored in a memory in association with the registered light source in advance, a coordinate position at which the first camera images the plurality of registered light sources and a first direction in which the first camera images the plurality of registered light sources and also derives, by detecting a second direction that allows an unregistered light source, the unregistered light source being newly installed at a position at a predetermined height, to fall within an angle of view of the first camera as viewed from a coordinate position at which the plurality of registered light sources is imaged, an installation coordinate position at which the unregistered light source is installed, and stores information about the derived installation coordinate position in the memory in association with information about a light emission pattern of the unregistered light source as information about a new registered light source.

### BRIEF DESCRIPTION OF DRAWINGS

A more complete understanding of this application can be obtained when the following detailed description is considered in conjunction with the following drawings, in which:

FIG. 1 is a diagram describing a position calculation system according to an embodiment;

FIG. 2 is a diagram describing a position calculation (information collection) device (only one imager and one moving body are illustrated for viewability) and a terminal according to the embodiment;

FIG. 3 is a diagram illustrating an example of a configuration of the moving body and the imager in the position calculation (information collection) device according to the embodiment;

FIG. 4 is a diagram illustrating an example of a light source and others information integrated table according to the embodiment; and

FIG. 5 is a flowchart illustrating a flow of newly installed light source position calculation processing according to the embodiment.

### DETAILED DESCRIPTION OF THE INVENTION

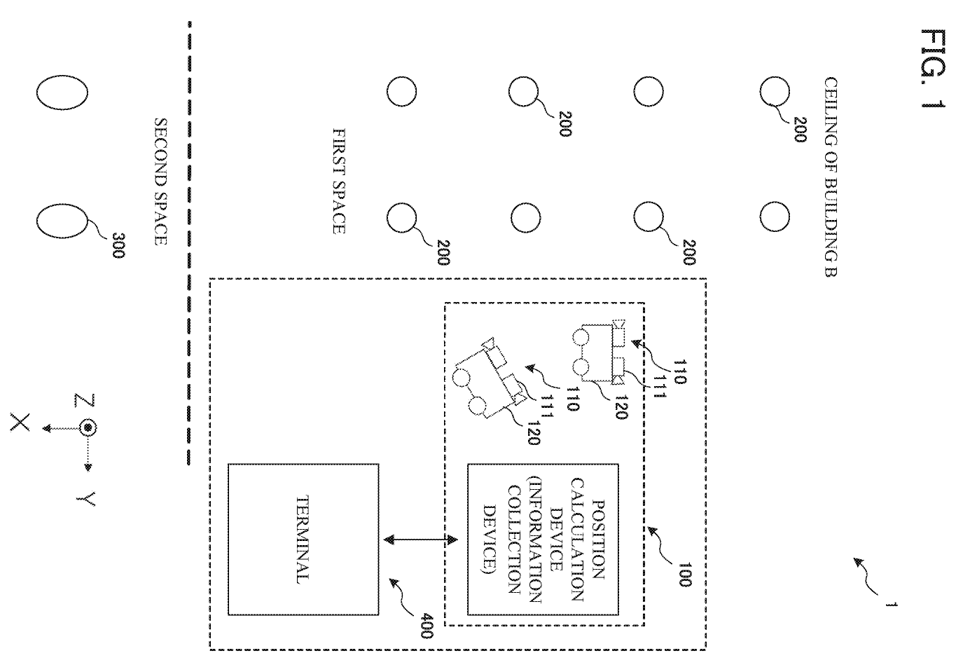

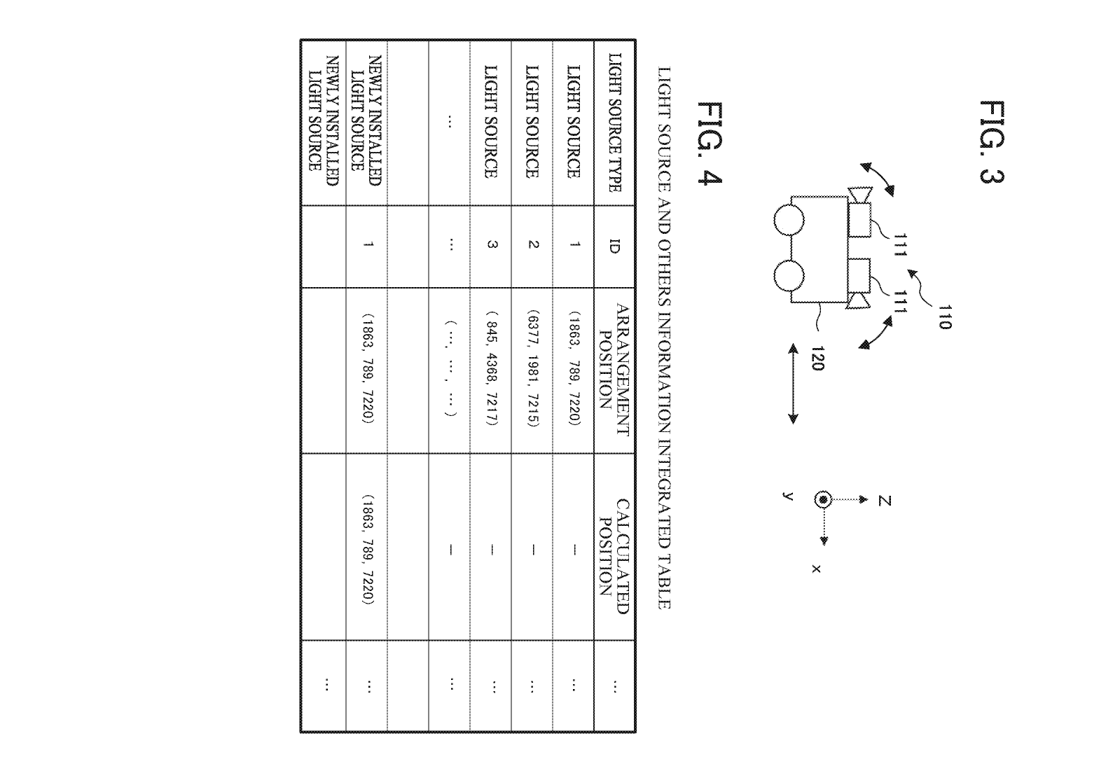

An embodiment of the present disclosure is described below with reference to the drawings. Note that the same or corresponding parts in the drawings are designated by the same reference numerals. To facilitate understanding, a Cartesian coordinate system XYZ is set. As illustrated in FIG. 1, it is assumed that the Z-axis direction is aligned with a height direction of a building B, the X-axis direction is aligned with a direction in which a first space and a second space are adjacent to each other, and the Y-axis direction is aligned with a direction orthogonal to the Z-axis direction and the X-axis direction. In addition, as illustrated in FIG. 3, it is also assumed that with respect to a moving body 120 of a position calculation device 100, a height direction of the moving body 120 is a z-axis, the longitudinal direction of the moving body 120 is an x-axis, and a Y-axis direction is a direction orthogonal to both the z-axis direction and x-axis direction. Hereinafter, the embodiment is described with reference to the coordinate systems.

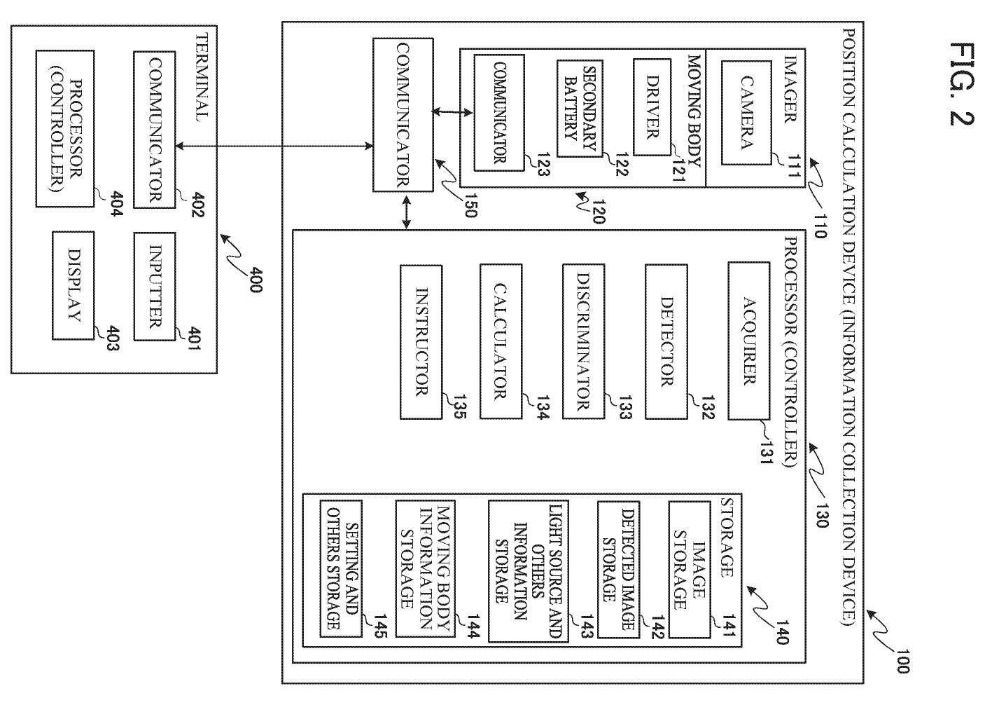

As illustrated in FIG. 1, a position calculation system 1 according to the embodiment includes the position calculation device 100 that performs positioning of a position of a newly installed light source 300, a position of a moving body 120 that receives light of visible light communication emitted from a light source 200, and the like, using the visible light communication, a light source 200 that is communicable with the position calculation device 100 through the visible light communication, a newly installed light source 300 that is newly installed, and a terminal 400 that operates the position calculation device 100. The position calculation device (information collection device) 100 is a moving camera-type device that is mainly used in a warehouse or a factory. As illustrated in FIG. 2, the position calculation device 100 is a device including an imager 110 that images a light source 200, a newly installed light source 300, and the like, a moving body 120 that moves the imager 110, a processor 130 that performs processing of an image imaged by the imager 110 and the like, and a communicator 150 that communicates with the terminal 400.

The imager 110 has a camera 111 that images a light source 200 and a newly installed light source 300. As illustrated in FIG. 3,there are two imagers 110 similar to two moving bodies 120, and the imager 110 has two cameras 111 in the present embodiment. Each of the cameras 111 is a receiver in visible light communication with a light source 200, and is, for example, a single chip color camera with high definition (HD) resolution equipped with a lens with a 90-degree view angle. The two cameras 111 are mounted on a single moving body 120 in such a way that the two cameras 111 point in directions opposite to each other (in the x-axis direction of the moving body 120, that is, in the traveling direction and the rearward direction (in the longitudinal direction)). This is because to broaden a detection range in the visible light communication and to prevent a correction error of optical distortion of a lens or the like. In addition, the cameras 111 can be rotated about the y-axis to adjust elevation angles, as illustrated by curved arrows in FIG. 3. Rotation of the cameras 111 about the z-axis is achieved by adjusting the longitudinal direction of the moving body 120 (causing the moving body 120 to turn right or left with respect to the traveling direction), and the cameras 111 do not rotate about the x-axis since a floor surface on which the moving body 120 moves is flat.

As illustrated in FIG. 2, a moving body 120 includes a driver 121 that drives the moving body 120 to operate, a secondary battery 122 that supplies power to the moving body 120, and a communicator 123 that communicates with the communicator 150 of a main body of the position calculation device 100. The driver 121 drives the moving body 120 to move in accordance with an instruction from an instructor 135 to be described later, and also changes the longitudinal direction of the moving body 120 in such a way that each camera 111 points in an instructed direction. The communicator 123 includes wireless communication modules conforming to a wireless communication standard, such as wireless local area network (LAN) and Bluetooth (registered trademark). The moving body 120 receives an instruction or the like from the terminal 400 via the communicators 150 and 123 and moves within a first space by causing the driver 121 to operate. The communicator 123 transmits an image imaged by a camera 111 to the main body of the position calculation device 100 via the communicator 150. In the present embodiment, the moving body 120 is dedicated equipment for imaging. In addition, not-illustrated various types of sensors are installed on the moving body 120 to measure the elevation angles or the like of the cameras 111.

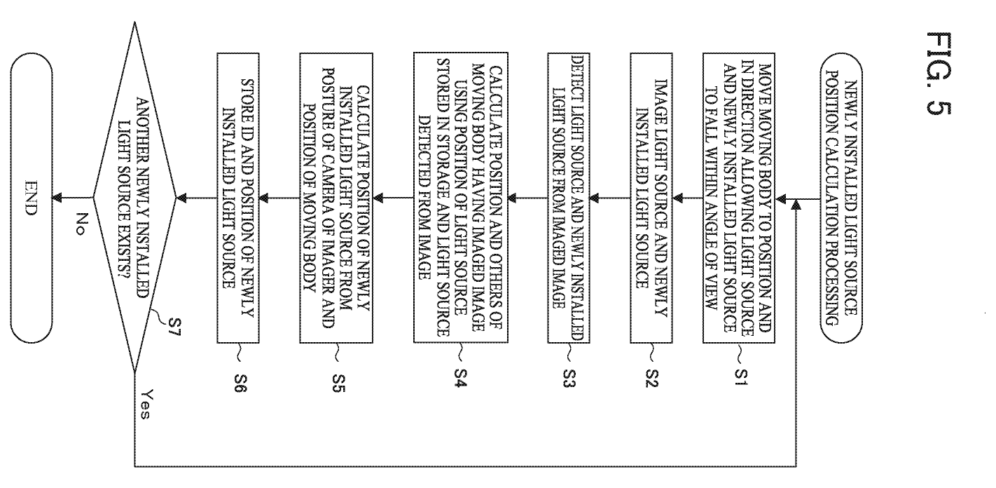

The processor 130 includes a central processing unit (CPU) and a storage 140. The storage 140 includes a read only memory (ROM) and a random access memory (RAM). The ROM includes a non-volatile memory, such as a flash memory, and stores a program, image data, and the like for the processor 130 to achieve various types of functions. The RAM includes a volatile memory and is used as a working area for the processor 130 to execute a program to perform various types of processing. The processor 130 functions as an acquirer 131, a detector 132, a discriminator 133, a calculator 134, and the instructor 135 by the CPU retrieving a program stored in the storage 140 and executing the retrieved program on the RAM. The processor 130 may also be referred to as "controller", "processor", or the like. The acquirer 131 acquires data of an image imaged by the imager 110 via the communicators 123 and 150 and stores the acquired data in an image storage 141. The detector 132 detects a predetermined shape or a shape resembling the predetermined shape within an image stored in the image storage 141, and stores the detected shape in a detected image storage 142 in conjunction with a detected position within the image. The predetermined shape is a shape corresponding to shapes of a light source 200 and a newly installed light source 300 to be detected from the image, and in the present embodiment, a circular shape or an elliptical shape corresponds to the shapes of the light source 200 and the newly installed light source 300. The discriminator 133 discriminates whether a detected object detected by the detector 132 is a light source 200 or a newly installed light source 300. Specifically, in a case where a blinking pattern (light emission pattern) of the detected object that is detected from images during a predetermined period, based on an optical communication signal emitted by the detected object, with reference to a setting and others storage 145 coincides with a blinking pattern of a light source 200 having a certain ID, the discriminator 133 discriminates the ID. In a case where there is no corresponding blinking pattern, the discriminator 133 discriminates that the blinking pattern is made by light from a newly installed light source 300. The discriminator 133 stores a discrimination result (the ID of a light source 200 or a result indicating that the detected object is a newly installed light source 300) in a light source and others information integrated table (an example of which is illustrated in FIG. 4) in a light source and others information storage 143 in conjunction with a position or the like of the light source 200 or the newly installed light source 300. Items in the light source and others information integrated table are a light source type (whether a light source is a light source 200 or a newly installed light source 300), an ID, an arrangement position (in a case of the light source 200, the arrangement position is transcribed from the setting and others storage 145, and in a case of the newly installed light source 300, a calculated position is transcribed), a calculated position, and the like. The calculator 134 calculates a position (coordinate position) of a moving body 120, using the position (installation coordinate position) of a light source 200 acquired from the light source and others information integrated table or the like stored in the light source and others information storage 143, and stores the calculated position (coordinates position) in a moving body information storage 144. The position calculation is performed using a calculation method described in paragraphs 0042 to 0062 in the description, FIG. 7, and the like in Unexamined Japanese Patent Application Publication No. 2023-43631. Note that another calculation method may be used. In addition, the calculator 134 calculates a position (installation coordinate position) of a newly installed light source 300, based on the position of a light source 200, the calculated position and direction of a moving body 120, the angle of a camera of the moving body 120, and the like. The instructor 135 instructs a moving body 120 to operate, based on a program stored in the storage 140 to cause the moving body 120 to operate or based on an instruction or the like from a user received by the terminal 400. In addition, in the storage 140, the setting and others storage 145 in which various thresholds, a program to cause the moving body 120 to operate, dimensions and a shape of the first space, the pre-measured position (installation coordinate position) of a light source 200 in the first space, the ID of the light source 200, a blinking pattern for each ID, camera offset values indicating the installation positions (installation height) of the cameras 111 on a moving body 120, and the like are stored is provided.

The communicator 150 includes wireless communication modules conforming to a wireless communication standard, such as wireless local area network (LAN) and Bluetooth (registered trademark), as with the communicator 123. The communicator 150 communicates with the terminal 400 and the communicator 123 of a moving body 120. In addition, the communicator 150 is capable of accessing a network such as the Internet.

As illustrated in FIG. 1, a light source 200 is, for example, an LED ceiling light mounted on a ceiling of the first space with a width of approximately 50 m, a depth of approximately 50 m, and a height of 7.2 m in the building B, and for example, eight light sources 200 are installed. In the first space, it is possible to calculate the position of a moving body 120 (and the cameras 111), using the light sources 200. Each of the light sources 200 is a light source that has been previously installed in the building B and that was subjected to positioning using a total station or the like by the user. The position (installation coordinate position) of each light source 200 is stored in the light source and others information storage 143 to be described later. Each of the light sources 200 is also a transmitter that transmits a signal in visible light communication with the position calculation device 100. Each of the light sources 200, for example, has a size of a diameter of 10 cm and a height of 10 cm and approximately one million combinations of color change patterns to be transmitted as signals (the light source 200 blinks once every 0.1 seconds (10 fps) and the number of blinks is 24). In addition, since each light source 200 has a unique ID and blinking pattern, the ID of a light source 200 detected by the detector 132 is discriminated by the discriminator 133, based on the blinking pattern. Since the light sources 200 transmit emission colors of the LED lights as signals as described above, the light sources 200 are capable of coping with an environment in which use of radio waves is restricted, such as a place where there is interference of radio waves, shielding of radio waves, or restrictions due to information security reasons, and a situation in which a communication cable cannot be installed. The light sources 200 are also referred to as registered light sources since information such as the installation coordinate positions at which the light sources 200 are installed and the light emission patterns is registered in the position calculation device 100. Note that in the present embodiment, the floor surface of the building B is flat, and two or more light sources 200 are required to be installed.

A newly installed light source 300 is, for example, an LED ceiling light mounted on a ceiling of the second space with a width of approximately 50 m, a depth of approximately 20 m, and a height of 7.2 m in the building B, and is also a light source that is capable of performing visible light communication, as with the light source 200. The second space is a newly installed (operation) area adjacent to the first space in the X-axis direction. The newly installed light source 300 is a light source that was installed after the light sources 200 and that has not been subjected to positioning using the total station or the like by the user. Therefore, before calculating the position of the newly installed light source 300, the position calculation of a moving body 120 (and cameras 111) cannot yet be performed in the second space. Note that since each newly installed light source 300 has a unique blinking pattern (light emission pattern) as with the light source 200, an ID is assigned to each newly installed light source 300 detected by the detector 132, by the discriminator 133, based on the blinking pattern. The newly installed light source 300 is also referred to as an unregistered light source since information such as an installation coordinate position at which the newly installed light source 300 is installed, a light emission pattern, and the like is not registered in the position calculation device 100. The newly installed light source 300 is stored in the light source and others information storage 143 as a new registered light source after the installation position coordinates are derived.

The terminal 400 includes an inputter 401 that accepts user input, a communicator 402 that communicates with the communicator 150 and the like, a display 403 that displays information and the like acquired via the communicator 402 to the user, a processor 404, and the like. The terminal 400 is capable of operating a moving body 120 by operation input to the inputter 401 by the user. The communicator 402 includes wireless communication modules conforming to a wireless communication standard, such as wireless LAN and Bluetooth (registered trademark), as with the communicators 123 and 150, and communicates with the communicator 150. The terminal 400 collects position information and the like of a moving body 120, other mobile equipment, and the like acquired from the position calculation device 100, via the communicators 402 and 150, and the user uses the collected information for a higher-level system, such as a flow line analysis system and a position management system. The user, for example, analyzes a bottleneck from a wasteful operation flow line, a stagnation point, or the like of mobile equipment and uses the analyzed bottleneck in layout change in a warehouse or a factory and improvement in a work process.

Next, newly installed light source position calculation processing executed by the position calculation device 100 of the position calculation system 1 having the configuration described above is described with reference to FIG. 5. The newly installed light source position calculation processing illustrated in FIG. 5 is an example of a newly installed light source position calculation method. The newly installed light source position calculation processing is processing of calculating the position and the like of each moving body 120 and subsequently calculating the position of a newly installed light source 300, using the positions of the light sources 200 stored in the light source and others information storage 143 in advance, a plurality of images in which the light sources 200 and the newly installed light source 300 are imaged by (the cameras 111 of) each imager 110, and the like. Note that it is not necessarily required that both a light source 200 and a newly installed light source 300 appear in one image and, for example, a method in which two light sources 200 are imaged by the front camera 111 of an imager 110 and one newly installed light source 300 is imaged by the rear camera 111 of the imager 110 may be used. In other words, each imager 110 may image two or more light sources 200 and one or more newly installed light sources 300. Using a plurality of pieces of calibration data imaged by a plurality of cameras from a plurality of positions, each piece of calibration data including an imaged image and a position (coordinate position) and an angle (an elevation angle and a direction) of a camera that images the image, the position (installation coordinate position) of the newly installed light source 300 can be calculated (derived) with high accuracy. Therefore, in the newly installed light source position calculation processing executed by the present system, it is possible to accurately calculate the position of the newly installed light source 300 without performing positioning by the total station or the like.

First, in response to the newly installed light source position calculation processing being started, the instructor 135, in accordance with an instruction that the user input or a program stored in the setting and others storage 145, instructs a plurality of moving bodies 120 to take a predetermined posture (a position (coordinate position) and a direction) and adjust the elevation angles of the cameras 111 in such a way that the first space and the second space are imaged within an angle of view of one of the cameras 111 of the imager 110 of the moving body 120 (or within a combined angle of view of both cameras 111 of an imager 110) (step S1). In response to the plurality of moving bodies 120 having taken predetermined postures and the cameras 111 having had predetermined elevation angles, the imager 110 of each moving body 120 performs imaging of the light sources 200 and the newly installed light source 300 for a predetermined period and generates images (step S2). The acquirer 131 acquires a plurality of images during the predetermined period via the communicators 123 and 150 and stores the acquired images in the image storage 141. The detector 132 detects, with respect to each of the plurality of images stored in the image storage 141, a light source 200 and a newly installed light source 300 that have the predetermined shapes or shapes resembling the predetermined shapes and stores the detected objects in the detected image storage 142 in conjunction with detected positions within the image (step S3). The discriminator 133 discriminates whether each detected object that is included in each image stored in the detected image storage 142 is a light source 200 or a newly installed light source 300, using blinking patterns or the like stored in the setting and others storage 145. The discriminator 133 stores a discrimination result (the ID of a light source 200 or a result indicating that the detected object is a newly installed light source 300) in the light source and others information integrated table in the light source and others information storage 143. The calculator 134 calculates (derives) the positions of each of the moving bodies 120 and the cameras 111, using the positions of the light sources 200 and the light source and others information integrated table stored in the light source and others information storage 143, and the camera offset values stored in the setting and others storage 145 (step S4).

The calculator 134 calculates a two-dimensional position of a newly installed light source 300 in an image, based on the positions of the light sources 200, the calculated positions and directions of the moving body 120 and the cameras 111, and angles (elevation angles) of the cameras 111 of the moving body 120, and subsequently calculates three-dimensional position of the newly installed light source 300, using the foregoing (step S5). The calculator 134 assigns an ID to the newly installed light source 300 and stores the calculated position of the newly installed light source 300 in the light source and others information integrated table in the light source and others information storage 143 in conjunction with the ID (step S6). The discriminator 133 discriminates, with reference to the light source and others information integrated table in the light source and others information storage 143, whether or not there remains a newly installed light source 300 to which no ID and no position (calculated position) have yet been provided (step S7). In a case where there remains a newly installed light source 300 to which no ID and no position have not been provided (step S7: Yes), the process returns to step S1, and in a case where there remains no newly installed light source 300 to which no ID and no position have not been provided (step S7: No), the newly installed light source position calculation processing terminates.

As described in the foregoing, the position calculation system 1 according to the present embodiment images two or more light sources 200 arranged in the first space and a newly installed light source 300 arranged in the second space adjacent to the first space from different positions (coordinate positions) and directions into a plurality of images, using the imager 110, and calculates the position of the moving body 120 on which the imager 110 is mounted in the first space, using the positions of two or more light sources 200 in the plurality of images and the positions of two or more light sources 200 stored in the storage 140. Since subsequently, the position calculation system 1 calculates the position of the newly installed light source 300 in the second space, using the positions of the two or more light sources 200 and the calculated position of the moving body 120, a cost and burden of the positioning using the total station or the like performed by the user can be eliminated, and since the position of the moving body 120 (and the cameras 111) is calculated using a plurality of images imaged from different positions, calculation accuracy can be improved. Therefore, the position of the newly installed light source 300 can be calculated with high accuracy, and further, since the position of the newly installed light source 300 can be calculated, it is also possible to calculate the position of a moving body 120 in the second space. In addition, various human errors associated with positioning performed by a person can be avoided, and further, it is not necessary to stop operation of a factory or a warehouse to perform positioning. In addition, since the position calculation system 1 uses a light source 200 the position of which is fixed, the position calculation system 1 can calculate positions more accurately than a system in which a machine itself produces an environment map.

In other words, the position calculation system 1 according to the present embodiment functions as an information collection device. The information collection device includes a moving body on which a first camera is mounted and at least one processor.

The at least one processor derives, based on an image obtained by imaging a plurality of registered light sources each of which has information about a light emission pattern and information about an installation coordinate position stored in a memory in association with the registered light source in advance, a coordinate position at which the first camera images the plurality of registered light sources and a first direction in which the first camera images the plurality of registered light sources and also derives, by detecting a second direction that allows an unregistered light source, the unregistered light source being newly installed at a position at a predetermined height, to fall within an angle of view of the first camera as viewed from a coordinate position at which the plurality of registered light sources is imaged, an installation coordinate position at which the unregistered light source is installed.

The at least one processor stores information about the derived installation coordinate position in the memory in association with information about a light emission pattern of the unregistered light source as information about a new registered light source.

In addition, the at least one processor, in a case where the newly installed unregistered light source does not fall within an angle of view of the first camera as viewed from a coordinate position at which the registered light sources are imaged, preferably moves a position of the first camera by causing the moving body to move to a coordinate position at which the newly installed unregistered light source falls within an angle of view of the first camera and subsequently detects a second direction that allows the newly installed unregistered light source to fall within an angle of view of the first camera, and also derives an installation coordinate position at which the unregistered light source is installed, using a direction in and distance by which a position of the first camera is moved as offset information.

In addition, the at least one processor, in a case where the newly installed unregistered light source does not fall within an angle of view of the first camera as viewed from a coordinate position at which the registered light sources are imaged, preferably detects, with respect to a second camera located at a position that allows the newly installed unregistered light source to fall within an angle of view, a second direction that allows the newly installed unregistered light source to fall within an angle of view of the second camera, and also derives an installation coordinate position at which the unregistered light source is installed, using a direction in and distance by which the second camera is separated from the first camera as offset information.

Note that the second camera is preferably mounted on the moving body on which the first camera is mounted and mounted on the moving body in such a way as to point in a direction different from the first camera.

In addition, the at least one processor preferably detects a light emission pattern of the unregistered light source, based on an image obtained by imaging the unregistered light source in the second direction that allows the unregistered light source to fall within an angle of view.

Although the embodiment of the present disclosure is described above, the above-described embodiment is an example, and the scope of application of the present disclosure is not limited thereto. That is, various applications of the embodiment of the present disclosure are possible, and all possible embodiments are included in the scope of the present disclosure. For example, although in the above-described embodiment, the position calculation device 100 includes an imager 110 and a moving body 120, it may be configured such that a commercially available moving body equipped with a camera transmits an imaged image to a position calculation device 100 that does not have an imager. In addition, although the imager 110 of the position calculation device 100 is a mobile type device, the imager 110 may be a device integrated with the main body of the position calculation device 100 or a fixed type device that is fixed at a place located away from the main body of the position calculation device 100. In addition, the number of imagers 110 and moving bodies 120 may be one (in this case, images are imaged a total of two times or more at different locations), or may be three or more. For example, in a case where the number of imagers 110 and moving bodies 120 is set to four, the number of combinations of two moving bodies 120 is six and six pieces of position data are calculated for each of the light sources 200, the moving bodies 120, and the newly installed light sources 300. In a case where six pieces of data are compared with one another and a mean is calculated as a calculated position by excluding, if any, a piece of data the value of which largely deviates from a mean of the six pieces of data (for example, a value falling outside a range from the mean minus a standard deviation to the mean plus the standard deviation), the calculation accuracy can be improved. In addition, it may be configured such that a moving body 120 that imaged the original image used to calculate the data largely deviating from the mean is moved and caused to image an additional image, calibration is performed by performing position calculation again, and calculation accuracy is thereby improved.

Although in the above-described embodiment, the positions of two moving bodies 120 (cameras 111) and a newly installed light source 300 are calculated based on images imaged by two imagers 110, the positions of the two moving bodies 120 and the newly installed light source 300 may be calculated by causing the two moving bodies 120 to move to other positions in the first space and to image additional images of the light sources 200 and the newly installed light source 300 and using a similar method. Because of this configuration, accuracy of the position calculation can be improved.

Although in the above-described embodiment, as illustrated in FIG. 1, there are eight light sources 200 and two newly installed light sources 300, the number, positions, and the like of the light sources 200 and the newly installed light sources 300 may be changed according to area of the first space and second space where positioning is performed by the position calculation system 1, required accuracy of positions, or the like.

Although in the above-described embodiment, two cameras 111 are arranged on one moving body 120 in such a way as to point in directions opposite to each other, two cameras 111 may be arranged side by side in such a way that portions of angles of view of the cameras 111 overlap each other, and the position calculation may be performed using, for example, a stereo camera method. Alternatively, one camera 111 may be arranged on one moving body 120, or three or more cameras 111 may be arranged on one moving body 120.

Although in the above-described embodiment, the predetermined shape is a circle or an ellipse, the predetermined shape may also be another shape, such as a parallelogram and a square, or may be restricted to one shape. In addition, in order to prevent detection of an object other than the light source 200 or the newly installed light source 300 by mistake, for example, a predetermined size may be set as an additional discrimination criterion. The predetermined size may be set according to distance between the imager 110 and the light sources 200 and the newly installed light sources 300, required accuracy, or the like.

Although in the above-described embodiment, each moving body 120 is dedicated equipment for performing imaging, each moving body 120 may also be used as an unmanned transport vehicle or a manned transport vehicle, other movable work equipment, or the like at the same time.

Although in the above-described embodiment, the light sources 200 and the newly installed light sources 300 are mounted on the ceiling in the first space and the second space, the light sources 200 and the newly installed light sources 300 may also be mounted on a wall surface, equipment, or the like in the first space and the second space. The two or more light sources 200 and the one or more newly installed light sources 300 are only required to be arranged at positions that allow the light sources 200 and the newly installed light sources to fall within an angle of view of a camera 111 located at a position within the first space or positions that allow the light sources 200 and the newly installed light sources to be imaged by two cameras 111 mounted on one moving body 120.

Although in the above-described embodiment, regarding a camera 111, only the elevation angle can be changed, the posture of the camera 111 may be configured to be changeable about the y-axis and the z-axis or changeable about the x, y, and z-axes. Because of this configuration, it becomes possible to calculate a position within an area where a floor is not flat. Note that in this case, three or more light sources 200 are required to be installed.

Although in the above-described embodiment, the position calculation is performed using the light sources 200, for example, general lights installed on the ceiling or the wall surface of the building B may be used as some of the light sources 200.

In addition, the functions of the position calculation device (information collection device) 100 can be implemented by a computer such as a general personal computer (PC). Specifically, in the above-described embodiment, the description is made assuming that the program for the position calculation processing performed by the position calculation device 100 is stored in advance in the ROM of the storage 140. However, it is also possible to configure a computer that can achieve the above-described functions by storing the program in a non-transitory computer-readable recording mediums, such as a flexible disk, a compact disc read only memory (CD-ROM), a digital versatile disc (DVD), and a magneto-optical disc (MO), distributing the non-transitory computer-readable recording medium, and reading in and installing the program in a computer.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. An information collection device, comprising:
a moving body on which a first camera is mounted; and
at least one processor,
wherein the at least one processor
derives, based on an image obtained by imaging a plurality of registered light sources each of which has information about a light emission pattern and information about an installation coordinate position stored in a memory in association with the registered light source in advance, a coordinate position at which the first camera images the plurality of registered light sources and a first direction in which the first camera images the plurality of registered light sources and also derives, by detecting a second direction that allows an unregistered light source, the unregistered light source being newly installed at a position at a predetermined height, to fall within an angle of view of the first camera as viewed from a coordinate position at which the plurality of registered light sources is imaged, an installation coordinate position at which the unregistered light source is installed, and
stores information about the derived installation coordinate position in the memory in association with information about a light emission pattern of the unregistered light source as information about a new registered light source.

2. The information collection device according to claim 1, wherein
the at least one processor
in a case where the newly installed unregistered light source does not fall within an angle of view of the first camera as viewed from a coordinate position at which the registered light sources are imaged, moves a position of the first camera by causing the moving body to move to a coordinate position at which the newly installed unregistered light source falls within an angle of view of the first camera and subsequently detects a second direction that allows the newly installed unregistered light source to fall within an angle of view of the first camera, and also derives an installation coordinate position at which the unregistered light source is installed, using a direction in and distance by which a position of the first camera is moved as offset information.

3. The information collection device according to claim 1, wherein
the at least one processor
in a case where the newly installed unregistered light source does not fall within an angle of view of the first camera as viewed from a coordinate position at which the registered light sources are imaged, detects, with respect to a second camera located at a position that allows the newly installed unregistered light source to fall within an angle of view, a second direction that allows the newly installed unregistered light source to fall within an angle of view of the second camera, and also derives an installation coordinate position at which the unregistered light source is installed, using a direction in and distance by which the second camera is separated from the first camera as offset information.

4. The information collection device according to claim 3, wherein the second camera is mounted on the moving body on which the first camera is mounted.

5. The information collection device according to claim 4, wherein the second camera is mounted on the moving body in such a way as to point in a direction different from the first camera.

6. The information collection device according to claim 1, wherein the plurality of registered light sources and the unregistered light source are installed on a ceiling of a predetermined building as ceiling lights.

7. The information collection device according to claim 1, wherein the moving body is an unmanned transport vehicle.

8. The information collection device according to claim 1, wherein the plurality of registered light sources has the light emission patterns different from each other.

9. The information collection device according to claim 8, wherein a light emission pattern of the unregistered light source is different from a light emission pattern of each of the plurality of registered light sources.

10. The information collection device according to claim 1, wherein
the at least one processor
detects a light emission pattern of the unregistered light source, based on an image obtained by imaging the unregistered light source in the second direction that allows the unregistered light source to fall within an angle of view.

11. An information collection method executed by a device including a moving body on which a first camera is mounted, the information collection method comprising:
deriving, based on an image obtained by imaging a plurality of registered light sources each of which has information about a light emission pattern and information about an installation coordinate position stored in a memory in association with the registered light source in advance, a coordinate position at which the first camera images the plurality of registered light sources and a first direction in which the first camera images the plurality of registered light sources and also deriving, by detecting a second direction that allows an unregistered light source, the unregistered light source being newly installed at a position at a predetermined height, to fall within an angle of view of the first camera as viewed from a coordinate position at which the plurality of registered light sources is imaged, an installation coordinate position at which the unregistered light source is installed, and
storing information about the installation coordinate position derived in the deriving in the memory in association with information about a light emission pattern of the unregistered light source as information about a new registered light source.

12. The information collection method according to claim 11, wherein
the storing
in a case where the newly installed unregistered light source does not fall within an angle of view of the first camera as viewed from a coordinate position at which the registered light sources are imaged, moves a position of the first camera by causing the moving body to move to a coordinate position at which the newly installed unregistered light source falls within an angle of view of the first camera and subsequently detects a second direction that allows the newly installed unregistered light source to fall within an angle of view of the first camera, and also derives an installation coordinate position at which the unregistered light source is installed, using a direction in and distance by which a position of the first camera is moved as offset information.

13. The information collection method according to claim 11, wherein
the storing
in a case where the newly installed unregistered light source does not fall within an angle of view of the first camera as viewed from a coordinate position at which the registered light sources are imaged, detects, with respect to a second camera located at a position that allows the newly installed unregistered light source to fall within an angle of view, a second direction that allows the newly installed unregistered light source to fall within an angle of view of the second camera, and also derives an installation coordinate position at which the unregistered light source is installed, using a direction in and distance by which the second camera is separated from the first camera as offset information.

14. The information collection method according to claim 11, wherein
the storing
detects a light emission pattern of the unregistered light source, based on an image obtained by imaging the unregistered light source in the second direction that allows the unregistered light source to fall within an angle of view.

15. A non-transitory recording medium storing a program readable by a computer of a device, the device including a moving body on which a first camera is mounted, the program causing the computer to execute processing comprising:
deriving, based on an image obtained by imaging a plurality of registered light sources each of which has information about a light emission pattern and information about an installation coordinate position stored in a memory in association with the registered light source in advance, a coordinate position at which the first camera images the plurality of registered light sources and a first direction in which the first camera images the plurality of registered light sources and also deriving, by detecting a second direction that allows an unregistered light source, the unregistered light source being newly installed at a position at a predetermined height, to fall within an angle of view of the first camera as viewed from a coordinate position at which the plurality of registered light sources is imaged, an installation coordinate position at which the unregistered light source is installed, and
storing information about the installation coordinate position derived in the deriving in the memory in association with information about a light emission pattern of the unregistered light source as information about a new registered light source.

16. The non-transitory recording medium according to claim 15, wherein
the deriving
in a case where the newly installed unregistered light source does not fall within an angle of view of the first camera as viewed from a coordinate position at which the registered light sources are imaged, moves a position of the first camera by causing the moving body to move to a coordinate position at which the newly installed unregistered light source falls within an angle of view of the first camera and subsequently detects a second direction that allows the newly installed unregistered light source to fall within an angle of view of the first camera, and also derives an installation coordinate position at which the unregistered light source is installed, using a direction in and distance by which a position of the first camera is moved as offset information.

17. The non-transitory recording medium according to claim 15, wherein
the deriving
in a case where the newly installed unregistered light source does not fall within an angle of view of the first camera as viewed from a coordinate position at which the registered light sources are imaged, detects, with respect to a second camera located at a position that allows the newly installed unregistered light source to fall within an angle of view, a second direction that allows the newly installed unregistered light source to fall within an angle of view of the second camera, and also derives an installation coordinate position at which the unregistered light source is installed, using a direction in and distance by which the second camera is separated from the first camera as offset information.

18. The non-transitory recording medium according to claim 15, wherein
the storing
detects a light emission pattern of the unregistered light source, based on an image obtained by imaging the unregistered light source in the second direction that allows the unregistered light source to fall within an angle of view.
